(19) United States
(12) Patent Application Publication
(10) Pub. No.: US 2008/0186292 A1
(43) Pub. Date: Aug. 7, 2008

(54) Timing controller, liquid crystal display device having the same, and method of operating a timing controller

(75) Inventors: Jae-Wan Park, Anyang-si (KR); Chang Min Kim, Daejeon (KR); Jong Seon Kim, Seongnam-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 11/985,370

(22) Filed: Nov. 15, 2007

(30) Foreign Application Priority Data
Feb. 6, 2007 (KR) 10-2007-0012166

(51) Int. Cl. G06F 3/038

(52) U.S. Cl. 345/204; 345/211

(57) ABSTRACT

In a timing controller and a liquid crystal display device having the same, the timing controller includes a line memory block receiving and storing pixel data received at a first data transfer frequency, and outputting the stored pixel data at a second data transfer frequency. A control unit, which is connected to an output terminal of the line memory block, transfers pixel data output from the line memory block to an external frame memory at the second data transfer frequency and outputting pixel data, which is transferred from the frame memory, after converting the pixel data to a predetermined data format.

### CROSS-REFERENCE TO RELATED APPLICATIONS

This application claims priority under 35 U.S.C. §119 from Korean Patent Application No. 10-2007-0012166, filed on Feb. 6, 2007, the disclosure of which is hereby incorporated by reference herein as if set forth in its entirety.

### BACKGROUND OF THE INVENTION

1. Field of the Invention

Embodiments of the present invention relate to a timing controller and a liquid crystal display device having the same, and more particularly, to a timing controller capable of reducing frame memory interface bandwidth and a liquid crystal display device having the same.

2. Description of the Related Art

The resolution of a liquid crystal display is generally based on the number of integrated pixels per unit area in the display. Resolution can be increased by forming the liquid crystal display device in a larger format. Resolution can also be increased for displaying a high-quality image by increasing the integration density of pixels in the liquid crystal panel. With increased resolution, the number of pixel data to be processed and displayed is also increased. In view of this, methods and systems for handling an increase in the number of pixel data and methods and systems for increasing processing speed are required.

FIG. 1 is a block diagram of a general timing controller for a display. Referring to FIG. 1, the timing controller 10 includes a control unit 11, a selection circuit 12, a first line memory block 13, a second line memory block 14, a data format conversion unit 15, and a control signal generator 16.

The control unit 11 receives pixel data, which is output from a data interface circuit 20, and outputs it to a frame memory 30. The control unit 11 also receives pixel data output by frame from the frame memory 30. The selection circuit 12 receives the pixel data output from the control unit 11 and outputs the received pixel data to the first line memory 13 or the second line memory 14 based on a line memory, selection signal SEL generated by the control unit 11.

The first line memory block 13 and the second line memory block 14 respectively stores pixel data on a horizontal line of a received liquid crystal panel. The data format conversion unit 15 outputs pixel data P-DATA output from the first line memory block 13 or a second line memory block 14 after converting it to a predetermined data format based on a data driving method of the liquid crystal panel.

The control signal generator 16 outputs a gate driver control signal G/D and a source driver control signal S/D based on a control signal output from the control unit 11. However, the interface speed of the data interface circuit 20 and the timing controller 10 has a first, relatively low, frequency (e.g. 85 MHz) in the general timing controller 10. With an increase of the number of pixels integrated into a liquid crystal panel, the number of pixel data required for displaying the increased number of pixels is also increased.

Also, over-drive technology has been introduced in order to raise the response speed of a liquid crystal display, a 120 Hz technology has been introduced to improve a blurring phenomenon that can occur which can be a limitation of a hold-type display, and Super Patterned Vertical Alignment SPVA technology has been introduced which allows for expansion of angle of vision. In view of these recent technology improvements, the number of pixel data being processed is necessarily increased.

Accordingly, in order to apply the over drive technology, the 120 Hz technology, and the SPVA technology, and the like, to the liquid crystal display device, the liquid crystal display device includes a frame memory block 30 and further increases the transmission frequency or bandwidth between the timing controller 10 and the frame memory 30. However, when the data transmission frequency or the bandwidth is greater than a certain rate such as 200 MHz, it is difficult to acquire set up or hold time for accessing pixel data stored in the frame memory 30.

Therefore, it is desirable to increase a data transmission frequency or bandwidth between the frame memory 30 and the timing controller 10 to improve the processing speed of the increasing pixel data.

### SUMMARY OF THE INVENTION

Some embodiments of the present invention provide a timing controller that improves interface bandwidth between a frame memory and a timing controller, and a liquid crystal display device including the timing controller.

In one aspect, a timing controller comprises: a line memory block receiving and storing pixel data received at a first data transfer frequency, and outputting the stored pixel data at a second data transfer frequency; and a control unit, which is connected to an output terminal of the line memory block, transferring pixel data output from the line memory block to an external frame memory at the second data transfer frequency and outputting pixel data, which is transferred from the frame memory, after converting the pixel data to a predetermined data format.

In one embodiment, the timing controller further comprises: a data format conversion unit converting the pixel data output from the control unit to a data format corresponding to a driving method of a liquid crystal panel; and a control signal generator generating a plurality of control signals driving the liquid crystal panel in response to a control signal output from the control unit.

In another embodiment, the first data transfer frequency is higher than the second data transfer frequency.

In another embodiment, the line memory block includes: a first line memory block storing pixel data on an N^{th} horizontal line of a liquid crystal panel, wherein N is a natural number; and a second line memory block storing pixel data on an (N+1)^{th} horizontal line of the liquid crystal panel.

In another embodiment, the timing controller further includes a selection block selecting the first line memory block or the second line memory block in response to a selection signal.

In another embodiment, the first line memory block and the second line memory block respectively includes an odd line memory storing an odd pixel data and an even line memory storing an even pixel data.

In another aspect, a liquid crystal display device comprises the timing controller described above, and further comprises: a data interface circuit transferring received pixel data at a first data transfer frequency and outputting the received pixel data to the timing controller; a frame memory interfacing with the timing controller at a second data transfer frequency, receiving and storing the pixel data, and outputting stored pixel data to the timing controller by a frame unit; a liquid crystal panel including a plurality of source lines, a plurality of gate lines, and a plurality of pixels; a source driver driving the liquid crystal panel by converting the pixel data to a predetermined gamma voltage level based on a source control signal output from the timing controller; and a gate driver driving the liquid crystal panel based on a gate control signal output from the timing controller.

In one embodiment, the frame memory comprises SDRAM or DDR SDRAM.

In another aspect, a timing controller comprises: a first line memory block storing pixel data on an N^{th} horizontal line of a liquid crystal panel received by a first data transfer frequency, wherein N is a natural number; a second line memory block storing pixel data on an (N+1)^{th} horizontal line of the liquid crystal panel received by the first data transfer frequency; a selection block, which is connected to input terminals of the first and the second line memory block, outputting pixel data received from an external source to the first line memory block or the second line memory block in response to a line memory selection signal; a control unit, connected to output terminals of the first and the second line memory blocks, transferring pixel data output from the first and the second line memory blocks to a frame memory at a second data transfer frequency, converting pixel data output from the frame memory to a predetermined data format, and outputting the converted pixel data; a data format conversion unit converting pixel data output from the control unit to a data format corresponding to a driving method of the liquid crystal panel; and a control signal generator generating a plurality of control signals driving the liquid crystal panel in response to a control signal output from the control unit.

In one embodiment, the first line memory block and the second line memory block respectively includes an odd line, memory storing odd pixel data and an even line memory storing even pixel data.

In another embodiment, the line memory selection signal is output from the control unit.

In another embodiment, the first data transfer frequency is higher than the second data transfer frequency.

In another aspect, an operating method of a timing controller comprises: outputting pixel data received at a selection circuit at a first data transfer frequency to a first line memory block or a second line memory block in response to a line memory selection signal; the first line memory block storing pixel data on an N^{th}, where N is a natural number, horizontal line of a liquid crystal panel among the pixel data received at the first data transfer frequency; the second line memory block storing pixel data on an (N+1)^{th} horizontal line of the liquid crystal panel among the pixel data received at the first data transfer frequency; and transferring pixel data output from the first and the second line memory blocks with an external frame memory at a second data transfer frequency at a control unit, which is connected to an output terminal of the first and the second line memory block respectively.

In one embodiment, the method further comprises: converting pixel data output from the control unit to a data format corresponding to a driving method of the liquid crystal panel; and receiving a control signal output from the control unit and generating a plurality of control signals driving the liquid crystal panel.

In another embodiment, the first line memory block and the second line memory block respectively includes an odd line memory storing odd pixel data and an even line memory storing even pixel data.

In another embodiment, the first data transfer frequency is higher than the second data transfer frequency.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a general timing controller;

FIG. 2 is a block diagram of a liquid crystal display device according to an example embodiment of the present invention;

FIG. 3 is a block diagram of the timing controller illustrated in FIG. 2; and

FIG. 4 is a chart that illustrates the advantageous effects of a timing controller according to another example embodiment of the present invention.

### DETAILED DESCRIPTION OF THE EMBODIMENTS

Embodiments of the present invention will now be described more fully hereinafter with reference to the accompanying drawings, in which preferred embodiments of the invention are shown. The invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that when an element is referred to as being “connected”, “coupled”, or “adjacent” to another element, it can be directly connected or coupled to the other element or intervening elements may be present. In contrast, when an element is referred to as being “directly connected”, “directly coupled”, or “directly adjacent” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

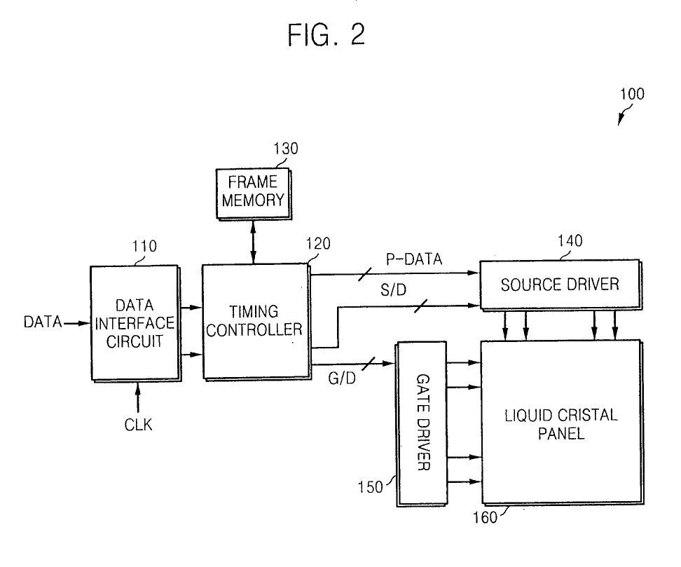

FIG. 2 is a block diagram of a liquid crystal display device according to an example embodiment of the present invention. Referring to FIG. 2, the liquid crystal display device 100 includes a data interface circuit 110, a timing controller 120, a frame memory 130, a source driver 140, a gate driver 150, and a liquid crystal panel 160.

The data interface circuit 110 operating in accordance with an LVDS interface method converts received pixel data DATA to a predetermined signal level, e.g., between 3.3V and 1.8V, and outputs level-converted pixel data in response to a first clock signal CLK having a first frequency.

The first frequency includes a predetermined overhead frequency. The overhead refers to extra time that is necessary for a normal driving operation of a liquid crystal panel 160. The timing controller 120 receives and outputs pixel data output from the data interface circuit 110 to the frame memory 130, and outputs pixel data P-DATA, which is output in a frame unit from the frame memory 130 to the source driver 140.

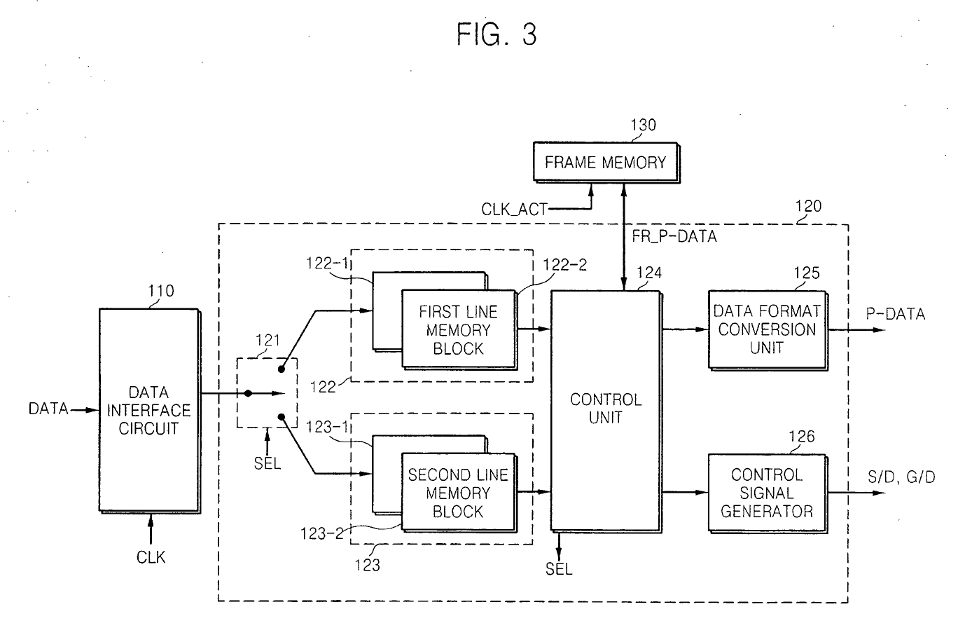

FIG. 3 is a block diagram of an embodiment of the timing controller 120 illustrated in FIG. 2. Referring to FIGS. 2 and 3, the timing controller 120 includes a selection block 121, a first line memory block 122 including a plurality of line memories 122-1 and 122-2, a second line memory block 123 including a plurality of line memories 123-1 and 123-2, a control unit 124, a data format conversion unit 125, and a control signal generator 126.

The selection block 121 receives pixel data, which is output in response to a first clock signal CLK having a first frequency, from the data interface circuit 110, and outputs received pixel data to the first line memory block 122 or the second line memory block 123 in response to a selection signal, SEL output from a control unit 124.

For example, the selection block 121 outputs received pixel data to the first line memory block 122 in response to a first level (e.g., logic ‘high’) of the selection signal SEL, and outputs received pixel data to the second line memory block 123 in response to a second level (e.g., logic ‘low’) of the selection signal SEL.

The first line memory block 122 stores pixel data on an N^{th} (N is a natural number, for example, N is larger than 2) horizontal line of the liquid crystal panel 160 among pixel data output from the selection block 121. The first line memory block 122 includes a first odd line memory 122-1 storing odd pixel data and a first even line memory 122-2 storing even pixel data among received pixel data of an N^{th} horizontal line.

The second line memory block 123 stores pixel data on an (N+1)^{th} horizontal line of the liquid crystal panel 160 among pixel data output from the selection block 121. The second line memory block 123 includes a second odd line memory 123-1 storing odd pixel data and a second even-line memory 123-2 storing even pixel data among received pixel data of an (N+1)^{th} horizontal line.

While the first line memory block 122 receives pixel data of the N^{th} horizontal line, the second line memory block 123 outputs pixel data of the (N−1)^{th} horizontal line, which is stored in advance. Also, while the second line memory block 123 receives pixel data of the (N+1)^{th} horizontal line, the first line memory block 122 outputs pixel data of the N^{th} horizontal line, which is stored in advance.

That is, since the first line memory block 122 and the second line memory block 123 output pixel data that are lined up, they store and output pixel data, which is received by the first frequency, to an active pixel frequency. The active pixel frequency is the first frequency excluding the overhead frequency.

The control unit 124 receives and outputs pixel data, which is output from the first line memory block 122 or the second line memory block 123, to the frame memory 130. The control unit 124 receives and outputs pixel data output from the frame memory 130 to the data format conversion unit 125.

The frame memory 130 includes a plurality of data input/output pins (not shown) in order to interface with the timing controller 120. The frame memory 130 receives and stores pixel data output from the control unit 124 through a data bus connected to the plurality of input/output pins, and outputs stored pixel data by frame to the control unit 124 in response to a second clock signal CLK_ACT having a second frequency. The frame memory 130 can be embodied, for example, as a volatile memory such as SDRAM or DDR SDRAM.

The second clock signal CLK_ACT has a frequency that is scaled relative to the transmission frequency (e.g., a first frequency) of the pixel data that is input to the timing controller 120 corresponding to the driving technology of the timing controller 120 (e.g., over drive technology, 120 Hz drive technology, and SPVA technology). That is, the first frequency is higher than the second frequency.

The data format conversion unit 125 converts pixel data output from the control unit 124 to a data format corresponding to the method used to drive the liquid crystal display device 160 (e.g., a dot inversion method, a line inversion method, and the like), and outputs the converted pixel data P-DATA.

The control signal generator 126 outputs control signals S/D and G/D, which control the signal transmission timing of the converted pixel data P-DATA output from the data format conversion unit 125, to the source driver 140 and the gate driver 150 in response to a control signal output from the control unit 124. The source driver 140 outputs the pixel data P-DATA to data lines of the liquid crystal panel 160 after converting the pixel data P-DATA to a predetermined gamma voltage level or a predetermined polarity based on the source driver control signal S/D output from the timing controller 120.

The gate driver 150 successively turns on gate lines embodied in the liquid crystal panel 160 based on a gate driver control signal G/D output from the timing controller 120.

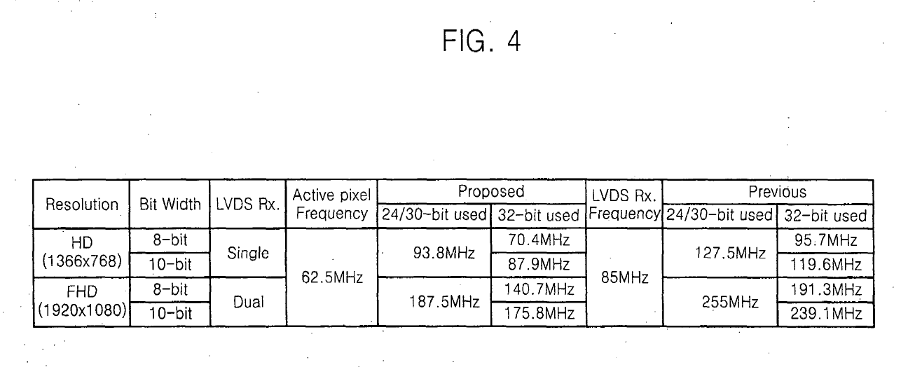

FIG. 4 is a chart that illustrates the advantageous effects of example embodiments of the present invention. FIG. 4 illustrates a case when an over-drive driving method is used, which drives 1.5 times or 3 times of an interface speed between a timing controller 120 supporting a high resolution and the frame memory 130.

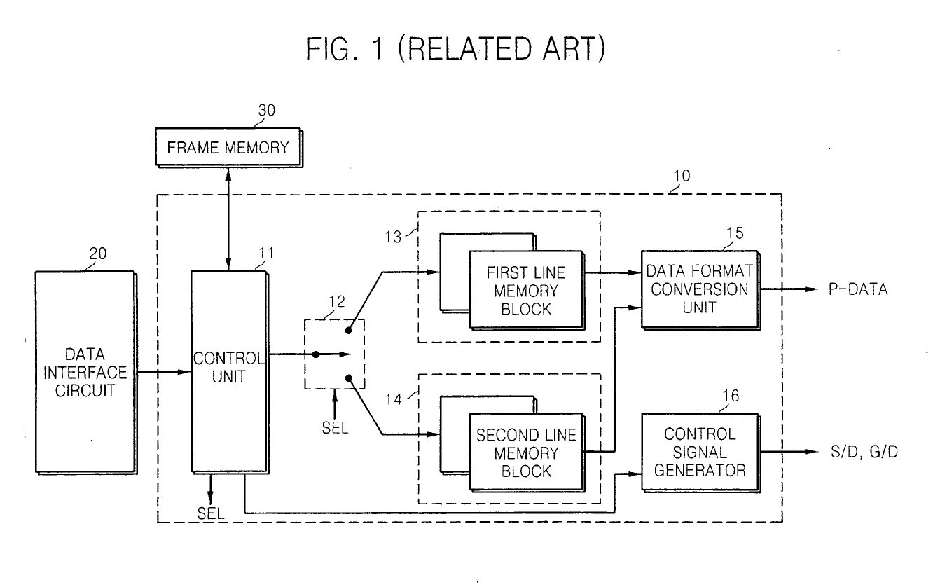

Referring to FIGS. 1 to 4, a frequency of pixel data output from a data interface circuit 110 has a frequency that corresponds to the combined active pixel frequency and an overhead frequency. For example, when a frequency of the output pixel data is 85 MHz, the active pixel frequency and the overhead frequency respectively become 62.5 MHz and 17.5 MHz. The desired ratio of the active pixel frequency relative to the overhead frequency may be determined during design of the system.

In the case of using a single data interface method, which drives a liquid crystal display device 100 having a HD (1366×768) level resolution, a conventional timing controller 10 interfaces pixel data to the frame memory 30 with 127.5 MHz of a transmission frequency when driving 1.5 times over-drive. On the other hand, a timing controller 120 according to embodiments of the present invention may interface pixel data to the frame memory 130 with a transmission frequency of 93.8 MHz when driving 1.5 times over drive.

That is, the timing controller 120 according to embodiments of the present invention can reduce a bandwidth by about 26.5% in comparison to a general timing controller by reducing overhead through outputting pixel data, which has a first frequency and output from the data interface circuit 110, through a line memory block 122 or 123. When a dual interface method is used, which drives a liquid crystal display device having a FHD (1920×1080) level resolution, a conventional timing controller 10 should interface with the frame memory 30 at a rate of about 255 MHz.

Also, the conventional timing controller 10, when interfacing pixel data composed of 10 bits to the frame memory 30, should drive at a transmission frequency of 239.1 MHz when all of 32 bits of the data bus are employed in interfacing the pixel data. Therefore, setup or hold time is marginally acquired when the general timing controller 10 accesses the frame memory 30.

On the other hand, a timing controller 120 in accordance with an embodiment of the present invention may interface with the frame memory 130 at a frequency of only 187.5 MHz when driving at the 3 times over-drive rate. Also, the timing controller 120 in accordance with an embodiment of the present invention may interface pixel data composed of 10 bits to the frame memory 130 at a transmission frequency of 175.8 MHz when 32 bits of the data bus are employed. Therefore, the frame memory 130 may more readily acquire sufficient setup or hold time and reduce interface bandwidth as compared to the conventional timing controller 10.

That is, a timing controller 120 according to the embodiments of the present invention can interface with the frame memory 130 with an active pixel data frequency that does not include an overhead frequency by locating the line memory blocks 122 and 123 before the control unit 124 without the need for adding additional circuitry. In addition, by reducing an interface bandwidth between the frame memory 130 and the timing controller 120, the timing controller 120 does not require an additional circuit for increasing the resolution, so that the timing controller 120 can be manufactured at a reduced cost.

As described above, a timing controller 120 in accordance with embodiments of the present invention and a liquid crystal display device 100 having the same can reduce an interface bandwidth between the timing controller 120 and a frame memory 130, and can reduce a manufacturing cost of the timing controller 120 and the frame memory 130.

While embodiments of the present invention has been shown and described with reference to exemplary embodiments thereof, it will be understood by those of ordinary skill in the art that various changes in form and detail may be made herein without departing from the spirit and scope of the present invention, as defined by the following claims.

What is claimed is:

1. A timing controller comprising:
a line memory block receiving and storing pixel data received at a first data transfer frequency, and outputting the stored pixel data at a second data transfer frequency; and
a control unit, which is connected to an output terminal of the line memory block, transferring pixel data output from the line memory block to an external frame memory at the second data transfer frequency and outputting pixel data, which is transferred from the frame memory, after converting the pixel data to a predetermined data format.

2. The timing controller of claim 1, further comprising:
a data format conversion unit converting the pixel data output from the control unit to a data format corresponding to a driving method of a liquid crystal panel; and
a control signal generator generating a plurality of control signals driving the liquid crystal panel in response to a control signal output from the control unit.

3. The timing controller of claim 1, wherein the first data transfer frequency is higher than the second data transfer frequency.

4. The timing controller of claim 1, wherein the line memory block includes:
a first line memory block storing pixel data on an N^{th} horizontal line of a liquid crystal panel, wherein N is a natural number; and
a second line memory block storing pixel data on an (N+1)^{th} horizontal line of the liquid crystal panel.

5. The timing controller of claim 4, wherein the timing controller further includes a selection block selecting the first line memory block or the second line memory block in response to a selection signal.

6. The timing controller of claim 4, wherein the first line memory block and the second line memory block respectively includes an odd line memory storing an odd pixel data and an even line memory storing an even pixel data.

7. A liquid crystal display device comprising the timing controller of claim 1, and further comprising:
a data interface circuit transferring received pixel data at the first data transfer frequency and outputting the received pixel data to the timing controller;
a frame memory interfacing with the timing controller at the second data transfer frequency, receiving and storing the pixel data, and outputting stored pixel data to the timing controller by a frame unit;
a liquid crystal panel including a plurality of source lines, a plurality of gate lines, and a plurality of pixels;
a source driver driving the liquid crystal panel by converting the pixel data to a predetermined gamma voltage level based on a source control signal output from the timing controller; and
a gate driver driving the liquid crystal panel based on a gate control signal output from the timing controller.

8. The liquid crystal display device of claim 7, wherein the frame memory comprises SDRAM or DDR SDRAM.

9. A timing controller comprising:
a first line memory block storing pixel data on an N^{th} horizontal line of a liquid crystal panel received by a first data transfer frequency, wherein N is a natural number;
a second line memory block storing pixel data on an (N+1)^{th} horizontal line of the liquid crystal panel received by the first data transfer frequency;
a selection block, which is connected to input terminals of the first and the second line memory block, outputting pixel data received from an external source to the first line memory block or the second line memory block in response to a line memory selection signal;
a control unit, connected to output terminals of the first and the second line memory blocks, transferring pixel data output from the first and the second line memory blocks to a frame memory at a second data transfer frequency, converting pixel data output from the frame memory to a predetermined data format, and outputting the converted pixel data;
a data format conversion unit converting pixel data output from the control unit to a data format corresponding to a driving method of the liquid crystal panel; and
a control signal generator generating a plurality of control signals driving the liquid crystal panel in response to a control signal output from the control unit.

10. The timing controller of claim 9, wherein the first line memory block and the second line memory block respectively includes an odd line memory storing odd pixel data and an even line memory storing even pixel data.

11. The timing controller of claim 9, wherein the line memory selection signal is output from the control unit.

12. The timing controller of claim 9, wherein the first data transfer frequency is higher than the second data transfer frequency.

13. An operating method of a timing controller comprising:
outputting pixel data received at a selection circuit at a first data transfer frequency to a first line memory block or a second line memory block in response to a line memory selection signal;
the first line memory block storing pixel data on an N^{th}, where N is a natural number, horizontal line of a liquid crystal panel among the pixel data received at the first data transfer frequency;
the second line memory block storing pixel data on an (N+1)^{th} horizontal line of the liquid crystal panel among the pixel data received at the first data transfer frequency; and
transferring pixel data output from the first and the second line memory blocks with an external frame memory at a second data transfer frequency at a control unit, which is connected to an output terminal of the first and the second line memory block respectively.

14. The method of claim 13, further comprising:
converting pixel data output from the control unit to a data format corresponding to a driving method of the liquid crystal panel; and
receiving a control signal output from the control unit and generating a plurality of control signals driving the liquid crystal panel.

15. The method of claim 13, wherein the first line memory block and the second line memory block respectively includes an odd line memory storing odd pixel data and an even line memory storing even pixel data.

16. The method of claim 13, wherein the first data transfer frequency is higher than the second data transfer frequency.
